(19) United States
(12) Patent Application Publication
(10) Pub. No.: US 2026/0322772 A1
(43) Pub. Date: Oct. 15, 2026

(54) AI-ASSISTED CONTENT GENERATION SYSTEM FOR CHURCH COMMUNICATIONS ACROSS MULTIPLE CHANNELS

(71) Applicants: Brock Moreau, Sanford, FL (US); Holly Moreau, Sanford, FL (US)

(72) Inventors: Brock Moreau, Sanford, FL (US); Holly Moreau, Sanford, FL (US)

(21) Appl. No.: 19/644,516

(22) Filed: Apr. 10, 2026

Related U.S. Application Data
(60) Provisional application No. 63/787,489, filed on Apr. 11, 2025.

(51) Int. Cl. H04L 51/04; H04L 51/212; H04L 51/52

(52) U.S. Cl. CPC H04L 51/04; H04L 51/212; H04L 51/52

(57) ABSTRACT

A system, method, and computer program product for generating multi-channel communication content for faith-based organizations. The system receives input data describing an event via a user interface and maps the input data to pre-structured prompt templates corresponding to a plurality of communication channels. A content generation engine interfaces with a large language model to generate a communication package comprising content items formatted for email, social media, SMS, and spoken announcements. The system displays each content item as a discrete element within a modular editing interface and supports selective regeneration of individual content items without regenerating the entire package. A content usage tracking module allows users to mark items as used and maintains metadata to prevent duplication. An archive module stores communication packages in a searchable database supporting retrieval by keyword, date, and ministry type.

### CROSS-REFERENCE TO RELATED APPLICATIONS

The present application claims priority to U.S. Provisional Application No. 63/787,489 filed Apr. 11, 2025, titled “AI-ASSISTED CONTENT GENERATION SYSTEM FOR CHURCH COMMUNICATIONS ACROSS MULTIPLE CHANNELS,” which is hereby incorporated by reference in its entirety.

### TECHNICAL FIELD

The embodiments generally to artificial intelligence-assisted content generation systems, and more particularly to systems, methods, and computer program products for generating multi-channel communication content for faith-based organizations.

### BACKGROUND

Effective communication has always been a cornerstone of church ministry. Historically, church communications were limited to verbal announcements during services, printed bulletins, and community noticeboards. As technology evolved, churches adopted additional tools such as email newsletters, websites, social media, and text messaging to engage with members and the broader community. This evolution has increased the complexity and frequency of communication demands, requiring church staff to manage content across multiple digital platforms while maintaining a consistent and faith-aligned message.

In most churches, especially small and mid-sized congregations, communications are managed by staff members or volunteers who juggle these responsibilities alongside other ministry duties. Messaging for events, ministries, and campaigns is often manually written using word processors, email software, or social media platforms. This manual process is time-intensive and prone to inconsistencies in tone, structure, and timing. Some churches turn to pre-written templates or subscription-based resources, but these often require significant customization and do not reflect the unique voice, mission, or culture of individual congregations.

With the rise of artificial intelligence writing tools, some churches have experimented with using general-purpose AI to generate content. However, these tools are not built with church-specific communications in mind. They lack the ability to ensure tone alignment with spiritual messaging, structured formats for ministry announcements, and support for multiple communication channels in a single workflow. Additionally, these tools often regenerate entire outputs when edits are needed, creating frustration and inefficiency when only small portions of content require revision.

Traditional marketing and scheduling platforms such as email distribution services and social media management tools have been employed to distribute content, but they offer limited support in content creation itself. These platforms assume that high-quality content has already been created externally. As a result, churches are forced to piece together a patchwork of tools and manual efforts to meet their communications needs, leading to burnout among staff and volunteers, message duplication, and missed opportunities to connect meaningfully with their audience.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The disclosed invention relates to a system, method, and computer program product for AI-assisted content generation specifically designed for church communications. The system provides a specialized toolset that allows churches to create, manage, and disseminate faith-aligned messaging across a variety of digital channels including email, social media, SMS, and spoken announcements.

The system includes a user interface configured to receive input data describing a church event, ministry update, or campaign. The input data comprises structured fields such as event name, date, target audience, and call-to-action message. This structured approach reduces cognitive load on users and ensures completeness of the input data, which improves the quality and relevance of the generated content.

A content generation engine processes the input data using a large language model guided by pre-structured prompt templates. These templates are crafted to reflect the linguistic style, tone, and structure of faith-based communication. By using targeted prompts rather than ad hoc AI interaction, the system guides the large language model toward output that is aligned with the spiritual and organizational values of churches.

The system generates a multi-channel communication package from a single input session. The communication package comprises a plurality of content items, each formatted for a respective communication channel. This approach ensures consistency in tone and message across platforms and reduces the time and coordination otherwise required for manual content creation across multiple channels.

Each content item in the communication package is presented within a modular editing interface as a discrete, individually selectable element. The system allows users to selectively regenerate specific content items without regenerating the entire communication package. This granular control saves time, reduces frustration, and allows for fine-tuning of only the elements that need adjustment.

The system includes a content usage tracking module that allows users to mark individual content items as used. This feature updates metadata associated with the content item to indicate a used status, helping prevent accidental duplication of messaging across communication cycles. The metadata may further comprise a timestamp and user identifier indicating when and by whom the content item was marked as used.

The system stores all generated communication packages in a searchable database with associated metadata. Users can retrieve previously stored communication packages based on filter criteria such as keyword, event date, event title, ministry type, audience type, or communication channel. Retrieved communication packages can be cloned and adapted for future events, enabling efficient reuse of previously approved messaging.

In some embodiments, the system performs a website scan of an existing church website to extract tone markers, personality indicators, and communication style characteristics. The system generates a communication style profile based on the extracted characteristics and incorporates the profile into the prompt templates such that generated content reflects a consistent voice matching the church's established communication style.

In some embodiments, the system applies a member journey map framework that structures communications around stages of a church member experience. The system generates a coordinated sequence of messages comprising pre-event announcements, event reminders, and post-event follow-up messages, with each message associated with a designated timing parameter relative to the event date.

The system includes a user authentication module that authenticates users and assigns roles with different permission levels. Roles may include content creator, editor, and approver, allowing churches to delegate communication responsibilities according to team structure while maintaining accountability and message integrity.

The system operates on a cloud-based infrastructure that supports secure access from various devices and geographic locations. This architecture enables real-time collaboration and multi-user access, which is beneficial for churches with distributed teams or multiple ministries working concurrently on communications.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a flowchart of a process for generating tailored communication content for church-related events using artificial intelligence, according to some embodiments;

FIG. 4 illustrates a flowchart of a method for generating tailored communication content for church-related events using artificial intelligence, according to some embodiments

FIG. 5 illustrates an exemplary user interface screen of a communication package editor displaying a modular editing interface for reviewing and managing AI-generated multi-channel communication content, according to some embodiments; and

FIG. 6 illustrates an exemplary data structure diagram depicting the organization of a communication package record and associated content items as stored in the archive database, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

The following detailed description provides an in-depth technical explanation of various embodiments of a system, method, and computer program product for generating multi-channel communication content for faith-based organizations. The specific details of the embodiments described herein are provided for demonstration purposes and are not intended to limit the scope of the claims. Many modifications and variations will be apparent to those of ordinary skill in the art without departing from the scope and spirit of the described embodiments.

The system operates as a cloud-based software platform accessible via a web browser or dedicated application. The system comprises one or more processors coupled to one or more non-transitory computer-readable storage media. The storage media stores instructions that, when executed by the processors, cause the system to perform the operations described herein. The system may be implemented on a standalone server, a distributed computing environment, or a cloud computing infrastructure such as a software-as-a-service (SaaS) platform.

The system comprises several functional modules that work in coordination to generate, manage, and store communication content. These modules include a user interface module, a prompt engine, a content generation engine, a multi-channel packaging module, an editing module, a content usage tracking module, and an archive module. Each module may be implemented as software instructions executed by the one or more processors, as dedicated hardware components, or as a combination thereof.

The user interface module provides a web-based dashboard through which users interact with the system. The user interface module renders input forms, displays generated content, and presents navigation controls for accessing various system features. The user interface module may be rendered via a web browser using standard web technologies such as HTML, CSS, and JavaScript, or may be rendered via a native application on a desktop or mobile device.

The user interface module is configured to receive input data from a user describing a church event, ministry update, or campaign. The input data comprises structured fields that capture information relevant to generating communication content. These structured fields may include an event name, an event date, a target audience descriptor, a call-to-action message, a ministry type, and a preferred tone or theme. The user interface module presents these fields in an intuitive form layout that guides users through the input process.

The user interface module validates the input data to ensure completeness and coherence before passing the data to downstream modules. Validation may include checking for required fields, verifying date formats, and confirming that audience descriptors match predefined categories. Upon successful validation, the user interface module transmits the input data to the prompt engine for processing.

The user interface module also provides authentication functionality. Users access the system by providing login credentials such as a username and password. The system may support additional authentication mechanisms such as two-factor authentication or single sign-on integration. Upon successful authentication, the user interface module retrieves role information associated with the user account and adjusts the available features and permissions accordingly. Roles may include content creator, editor, and approver, each associated with different access permissions within the system.

The prompt engine receives validated input data from the user interface module and maps the data to a library of pre-structured prompt templates. The prompt engine maintains a collection of prompt templates, each designed to generate content suitable for a specific communication channel. The communication channels may include email, social media platforms, short message service (SMS), and spoken announcement scripts.

Each prompt template comprises a textual structure with placeholder variables corresponding to input data fields. For example, an email prompt template may include placeholders for event name, event date, target audience, and call-to-action. The prompt engine populates the placeholder variables with the corresponding values from the input data to produce a complete prompt ready for submission to a large language model.

The prompt templates incorporate linguistic structures and terminology conventions configured to generate content aligned with communication standards of faith-based organizations. These structures may include greeting conventions, closing phrases, and vocabulary choices that reflect the tone and values typical of church communications. The prompt templates may also include formatting instructions that guide the large language model to produce output conforming to channel-specific requirements, such as character length limits for social media posts or brevity requirements for SMS messages.

In some embodiments, the prompt engine enriches the prompt templates with contextual information derived from a communication style profile. The communication style profile comprises tone markers, personality indicators, and communication style characteristics associated with a particular church. The prompt engine incorporates these characteristics into the prompt templates such that the generated content reflects a voice consistent with the church's established communication style.

In some embodiments, the system performs a website scan of an existing website associated with a church to generate the communication style profile. The website scan extracts textual content from one or more pages of the existing website. The system analyzes the extracted textual content to identify tone markers such as formal versus casual language, personality indicators such as welcoming versus authoritative voice, and communication style characteristics such as sentence length and vocabulary complexity.

The system may perform the analysis using natural language processing techniques including sentiment analysis, readability scoring, and keyword frequency analysis. The system aggregates the results of the analysis to generate a communication style profile that quantifies the church's existing communication style. The communication style profile may be stored in the archive module and associated with the church's account for use in subsequent content generation sessions.

The content generation engine interfaces with a large language model to generate communication content based on the populated prompt templates. The large language model may comprise a transformer-based neural network architecture such as OpenAI's GPT or similar models capable of generating coherent natural language text based on input prompts.

The content generation engine transmits the populated prompt templates to the large language model via an application programming interface (API). The content generation engine may transmit multiple prompts in parallel or in sequence, with each prompt corresponding to a different communication channel. The large language model processes each prompt and returns generated text as a response.

The content generation engine receives the generated text from the large language model and passes the text to the multi-channel packaging module for formatting. The content generation engine may also log metadata associated with each generation request, including timestamps, user identifiers, and prompt identifiers, for auditing and analytics purposes.

The content generation engine supports both initial generation and selective regeneration workflows. During initial generation, the engine processes a batch of prompts to produce content for each designated communication channel. For selective regeneration, the engine receives a targeted prompt focusing on a single content element and regenerates only that element without affecting other content items in the communication package.

The multi-channel packaging module receives raw generated content from the content generation engine and formats the content into a structured communication package. The communication package comprises a plurality of content items, each formatted for a respective communication channel.

The multi-channel packaging module applies channel-specific formatting rules to each content item. For email content, the module may structure the output into a subject line and a message body, with appropriate line breaks and paragraph formatting. For social media content, the module may truncate or adjust text to conform to character limits imposed by various platforms. For SMS content, the module may enforce brevity constraints and remove formatting that is not supported in text messages. For spoken announcement scripts, the module may format the content for verbal delivery, including pacing cues or phonetic guidance where appropriate.

The multi-channel packaging module tags each content item with metadata indicating the content type, the target communication channel, and the generation timestamp. The module assembles the formatted content items into a unified communication package data structure that can be displayed, edited, stored, and retrieved as a single unit.

The editing module provides a granular interface for reviewing and modifying AI-generated content. The editing module receives the communication package from the multi-channel packaging module and renders each content item as a discrete, individually selectable element within the user interface.

The editing module displays each content item in an editable field where users can make real-time adjustments to the text. Users may modify wording, correct errors, or personalize content to match specific preferences. The editing module tracks changes made by users and may maintain a version history for each content item.

The editing module facilitates selective regeneration by allowing users to request regeneration of a specific content item without affecting other items in the communication package. When a user selects a content item for regeneration, the editing module passes the original input data and any user-specified modifications to the content generation engine. The content generation engine regenerates only the selected content item using the large language model, and the editing module replaces the previous version with the newly generated content while preserving all other content items unchanged.

The editing module may also provide a live preview panel that displays each content item in a format approximating its final appearance on the target communication channel. For example, the preview panel may display social media content within a mock-up of a social media post interface, or display email content within a simulated email client layout.

The content usage tracking module monitors and records the status of each content item within a communication package. The module allows users to mark individual content items as used, indicating that the content has been deployed to a communication channel.

When a user marks a content item as used, the content usage tracking module updates metadata associated with the content item to indicate a used status. The metadata may further comprise a timestamp indicating when the content item was marked as used, a user identifier indicating which user marked the content item, and an identifier of the destination platform where the content was deployed.

The content usage tracking module displays usage status indicators within the user interface. Content items that have been marked as used may be visually distinguished from unused items through color coding, icons, or labels. This visual feedback helps users avoid accidental duplication of messaging across communication cycles.

The content usage tracking module integrates with the archive module to persist usage status information. When a communication package is stored in the archive, the usage status of each content item is preserved as part of the package metadata. When a user retrieves a previously stored communication package, the usage status information is displayed to provide context about prior deployment.

The archive module stores all generated communication packages in a searchable database. The database may be implemented using a relational database management system, a document-oriented database, or a cloud-based storage service. The archive module interfaces with the database to perform storage, retrieval, and search operations.

When a user finalizes a communication package, the archive module saves the package to the database along with associated metadata. The metadata may include the event title, event date, ministry type, target audience, generation timestamp, author identifier, and usage status for each content item. The archive module may also apply tags or labels specified by the user to facilitate organization and retrieval.

The archive module supports retrieval of previously stored communication packages based on filter criteria. Users may search for packages by keyword, event date, event title, ministry type, audience type, or communication channel. The archive module queries the database based on the specified criteria and returns matching communication packages for display in the user interface.

The archive module enables users to clone previously stored communication packages for adaptation to new events. When a user selects a package for cloning, the archive module creates a copy of the package data structure and loads the copy into the editing module. The user may then modify the cloned content as needed for the new event without affecting the original stored package.

In some embodiments, the system applies a member journey map framework that structures communications around stages of a church member experience. The member journey map framework defines a sequence of communication touchpoints relative to an event, such as a pre-event announcement, an event reminder, and a post-event follow-up message.

When a user creates a communication package with the member journey map framework enabled, the system generates a coordinated sequence of messages rather than a single set of content items. Each message in the sequence is associated with a designated timing parameter relative to the event date. For example, a pre-event announcement may be designated for distribution two weeks before the event date, a reminder may be designated for one day before, and a follow-up may be designated for one day after.

The prompt engine selects prompt templates appropriate for each stage of the member journey. The prompt templates for pre-event announcements may emphasize awareness and invitation, while templates for reminders may emphasize urgency and logistics, and templates for follow-up messages may emphasize gratitude and next steps. The content generation engine generates content for each stage, and the multi-channel packaging module formats and packages each message with its associated timing parameter.

In some embodiments, the system supports export of finalized content to third-party platforms. The system may interface with email marketing platforms, social media scheduling tools, or text messaging services via APIs provided by those platforms. Users may initiate an export operation from the user interface, which transmits the formatted content to the selected third-party platform for scheduling or immediate distribution.

Each export format may be optimized to meet the requirements of its target platform. For example, email messages may be converted to HTML templates compatible with email marketing services, while social media posts may be formatted according to the specifications of individual social media platforms.

The system may be implemented on various computing hardware configurations. The one or more processors may comprise general-purpose microprocessors, digital signal processors, application-specific integrated circuits, field-programmable gate arrays, or any combination thereof. The processors execute instructions stored in the one or more non-transitory computer-readable storage media.

The non-transitory computer-readable storage media may include volatile memory such as random access memory (RAM) and non-volatile memory such as read-only memory (ROM), flash memory, solid-state drives, or magnetic disk storage. The storage media stores the application instructions implementing the modules described herein, as well as data including prompt templates, communication packages, user account information, and database contents.

The system may communicate with external services and user devices via one or more network interfaces. The network interfaces may support wired or wireless communication protocols including Ethernet, Wi-Fi, and cellular data networks. The system may communicate with the large language model via a network connection to an external API service, or may host the large language model locally on dedicated hardware.

The system may be deployed in a cloud computing environment that provides scalable computing resources on demand. The cloud computing environment may comprise virtual machines, containers, or serverless computing functions that execute the application instructions. The cloud deployment enables access from multiple geographic locations and supports concurrent access by multiple users.

In operation, a user accesses the system via the user interface module and authenticates using login credentials. Upon successful authentication, the user navigates to a content creation interface and enters input data describing a church event. The user interface module validates the input data and transmits the data to the prompt engine.

The prompt engine maps the input data to one or more prompt templates corresponding to the desired communication channels. The prompt engine populates the placeholder variables in each template with the input data values. If a communication style profile is available for the church, the prompt engine incorporates the profile into the templates.

The content generation engine transmits the populated templates to the large language model and receives generated text in response. The multi-channel packaging module formats the generated text into a communication package comprising content items for each channel. The editing module displays the communication package in the user interface, with each content item presented as a discrete element.

The user reviews the generated content and may edit individual items directly or request selective regeneration of specific items. For selective regeneration, the editing module passes the targeted request to the content generation engine, which regenerates only the selected item. The editing module updates the display with the newly generated content while preserving other items.

When the user is satisfied with the communication package, the user may mark individual items as used via the content usage tracking module. The archive module saves the finalized package to the database with associated metadata. The user may later retrieve the package from the archive for reference or clone the package for adaptation to future events.

The foregoing description has been presented for purposes of illustration and is not intended to be exhaustive or to limit the embodiments to the precise forms disclosed. Many modifications and variations are possible in light of the above teachings. The described embodiments were chosen to explain the principles involved and their practical applications, enabling others skilled in the art to utilize the embodiments with various modifications as are suited to the particular use contemplated.

Various implementations of the invention involve the technical field of artificial intelligence-assisted content generation systems including receiving, by one or more processors via a web-based user interface, structured input data describing a church event, the structured input data comprising an event name, an event date, a target audience descriptor, and a call-to-action; mapping, by the one or more processors, the structured input data to a plurality of prompt templates, wherein each prompt template of the plurality of prompt templates is configured to generate content for a different communication channel; transmitting, by the one or more processors, the plurality of prompt templates populated with the structured input data to a large language model; receiving, by the one or more processors from the large language model, generated text for each of the plurality of prompt templates; assembling, by the one or more processors, the generated text into a communication package comprising a plurality of discrete content items including at least an email message, a social media post, and a text message; presenting, by the one or more processors via the web-based user interface, the communication package in an editing interface wherein each discrete content item is independently selectable; receiving, by the one or more processors, a regeneration request specifying a particular content item of the plurality of discrete content items; regenerating, by the one or more processors using the large language model, the particular content item without regenerating remaining content items of the plurality of discrete content items; and storing, by the one or more processors, the communication package and associated metadata in a cloud-based database and are therefore necessarily rooted in computer technology. For example, the aforementioned steps are inherently computer-based and cannot be performed in the human mind. The present invention amounts to more than merely implementing the generic computer as a tool to gather, analyze, and output data because the steps of the present method, system, or product improve the field of artificial intelligence-assisted content generation systems by providing a technical solution that automates the generation of coordinated multi-channel communication content through a combination of pre-structured prompt templates, a content generation engine interfacing with a large language model, and a multi-channel packaging module that formats outputs for distinct communication platforms from a single input session. The system further implements selective regeneration functionality that allows component-level reprocessing of individual content items without regenerating the entire communication package, which represents a specific technical improvement over conventional AI content generation tools that require full regeneration of outputs when modifications are needed. The content usage tracking module maintains persistent metadata states for each content item, enabling the system to prevent duplication across communication cycles through automated status monitoring rather than manual human tracking. The website scanning functionality extracts and quantifies tone markers and communication style characteristics from existing web content to generate a communication style profile that is programmatically incorporated into prompt templates, ensuring consistent voice matching without requiring users to manually analyze and specify stylistic parameters. These technical features work together through specific interactions between the modules and engines to produce a result that could not be achieved by a human organizing activities with generic computer hardware, as the system performs automated natural language processing, parallel prompt population, selective component regeneration, and metadata-driven usage tracking through defined software architecture rather than merely digitizing manual communication drafting workflows. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

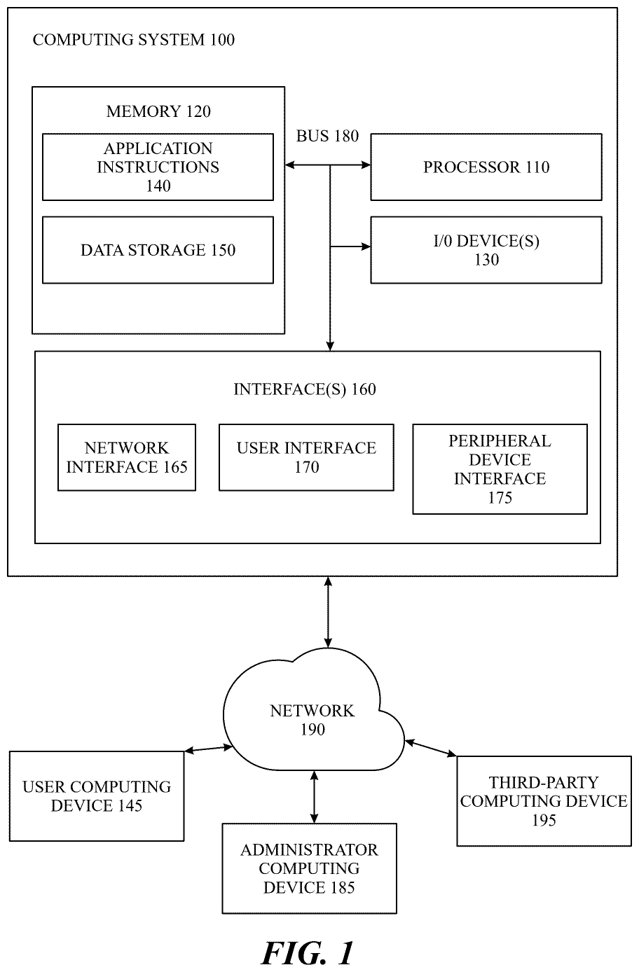

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, a medical diagnostic machine, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, depth sensors, biometric scanners, or environmental sensors. In industrial or medical environments, the I/O devices 130 may include robotic actuators, infusion pumps, or diagnostic imaging scanners. In vehicular environments, the I/O devices 130 may include in-cabin displays, steering sensors, and connected infotainment systems.

The computing system 100 further comprises one or more interfaces 160 that enable communication with other systems, users, or peripheral components. The network interface 165 allows the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart appliance configured to execute client-side applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 may be deployed in a client-server model, where the computing system 100 acts as a backend server managing requests from client devices. In other embodiments, the computing system 100 may function within a cloud-native environment, operating as a microservice within a container orchestration platform. In edge deployments, the computing system 100 may be optimized for low-latency local processing, while synchronizing with centralized cloud infrastructure for data persistence and global coordination.

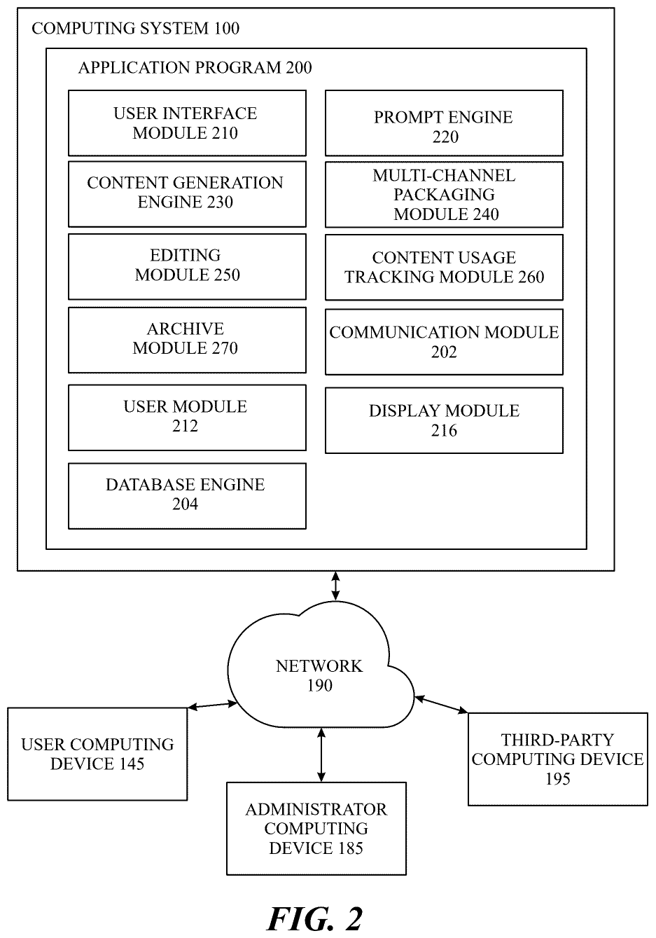

FIG. 2 illustrates a block diagram of a computing system 100 and an application program 200, according to some embodiments.

The computing system 100 comprises the application program 200, which executes on one or more processors within the computing system 100. The application program 200 comprises a plurality of modules and engines that coordinate to generate, manage, and store multi-channel communication content for faith-based organizations.

The user interface module 210 provides a web-based dashboard through which users interact with the application program 200. The user interface module 210 renders input forms configured to receive structured input data describing a church event, ministry update, or campaign. The input data may comprise an event name, an event date, a target audience descriptor, a call-to-action message, and a preferred tone or theme. The user interface module 210 validates the input data to ensure completeness and coherence and transmits the validated input data to downstream modules for processing. The user interface module 210 also presents generated content, navigation controls, and system status information to users.

The user module 212 handles user authentication and authorization functions. The user module 212 facilitates the creation of user accounts and manages login credentials including usernames and passwords. The user module 212 may support additional authentication mechanisms such as two-factor authentication or single sign-on integration. Upon successful authentication, the user module 212 retrieves role information associated with the user account and communicates the role to other modules within the application program 200. Roles may include content creator, editor, and approver, each associated with different access permissions. The user module 212 generates session tokens to maintain authenticated sessions and tags user activity with authenticated user metadata for auditing purposes.

The prompt engine 220 receives validated input data from the user interface module 210 and maps the input data to a library of pre-structured prompt templates. The prompt engine 220 maintains a collection of prompt templates, each designed to generate content suitable for a specific communication channel such as email, social media, SMS, or spoken announcement scripts. Each prompt template comprises a textual structure with placeholder variables corresponding to input data fields. The prompt engine 220 populates the placeholder variables with the corresponding values from the input data to produce complete prompts ready for submission to a large language model. The prompt templates incorporate linguistic structures and terminology conventions configured to generate content aligned with communication standards of faith-based organizations. In some embodiments, the prompt engine 220 enriches the prompt templates with contextual information derived from a communication style profile associated with a particular church.

The content generation engine 230 interfaces with a large language model to generate communication content based on the populated prompt templates received from the prompt engine 220. The content generation engine 230 transmits the populated prompt templates to the large language model via an application programming interface. The content generation engine 230 may transmit multiple prompts in parallel or in sequence, with each prompt corresponding to a different communication channel. The large language model processes each prompt and returns generated text as a response. The content generation engine 230 receives the generated text and passes the text to the multi-channel packaging module 240 for formatting. The content generation engine 230 supports both initial generation and selective regeneration workflows. During initial generation, the content generation engine 230 processes a batch of prompts to produce content for each designated communication channel. For selective regeneration, the content generation engine 230 receives a targeted prompt focusing on a single content element and regenerates only that element without affecting other content items in the communication package.

The multi-channel packaging module 240 receives raw generated content from the content generation engine 230 and formats the content into a structured communication package. The communication package comprises a plurality of content items, each formatted for a respective communication channel. The multi-channel packaging module 240 applies channel-specific formatting rules to each content item. For email content, the multi-channel packaging module 240 may structure the output into a subject line and a message body with appropriate formatting. For social media content, the multi-channel packaging module 240 may truncate or adjust text to conform to character limits imposed by various platforms. For SMS content, the multi-channel packaging module 240 may enforce brevity constraints. For spoken announcement scripts, the multi-channel packaging module 240 may format the content for verbal delivery. The multi-channel packaging module 240 tags each content item with metadata indicating the content type, the target communication channel, and the generation timestamp, and assembles the formatted content items into a unified communication package data structure.

The editing module 250 provides a granular interface for reviewing and modifying AI-generated content. The editing module 250 receives the communication package from the multi-channel packaging module 240 and renders each content item as a discrete, individually selectable element within the user interface module 210. The editing module 250 displays each content item in an editable field where users can make real-time adjustments to the text. The editing module 250 tracks changes made by users and may maintain a version history for each content item. The editing module 250 facilitates selective regeneration by allowing users to request regeneration of a specific content item without affecting other items in the communication package. When a user selects a content item for regeneration, the editing module 250 passes the original input data and any user-specified modifications to the content generation engine 230 for reprocessing. The editing module 250 replaces the previous version with the newly generated content while preserving all other content items unchanged.

The content usage tracking module 260 monitors and records the status of each content item within a communication package. The content usage tracking module 260 allows users to mark individual content items as used, indicating that the content has been deployed to a communication channel. When a user marks a content item as used, the content usage tracking module 260 updates metadata associated with the content item to indicate a used status. The metadata may further comprise a timestamp indicating when the content item was marked as used, a user identifier indicating which user marked the content item, and an identifier of the destination platform where the content was deployed. The content usage tracking module 260 displays usage status indicators within the user interface module 210 to help users avoid accidental duplication of messaging across communication cycles. The content usage tracking module 260 integrates with the archive module 270 to persist usage status information as part of stored communication packages.

The archive module 270 stores all generated communication packages in a searchable database managed by the database engine 204. When a user finalizes a communication package, the archive module 270 saves the package to the database along with associated metadata including event title, event date, ministry type, target audience, generation timestamp, author identifier, and usage status for each content item. The archive module 270 supports retrieval of previously stored communication packages based on filter criteria such as keyword, event date, event title, ministry type, audience type, or communication channel. The archive module 270 queries the database engine 204 based on specified criteria and returns matching communication packages for display. The archive module 270 enables users to clone previously stored communication packages for adaptation to new events by creating a copy of the package data structure and loading the copy into the editing module 250 for modification.

The communication module 202 is configured for receiving, processing, and transmitting data between the application program 200 and external devices connected via the network 190. The communication module 202 serves as an interface between users and the application program 200, capturing structured input data such as event titles, ministry type, target audience, key dates, and call-to-action messages through the user interface module 210. The communication module 202 processes the inputs and normalizes them into a standardized format for downstream use by the content generation engine 230. The communication module 202 ensures that user-submitted data is validated and semantically categorized for prompt template integration. The communication module 202 also provides user-facing feedback such as generation progress indicators and submission confirmation. The communication module 202 may interface with third-party computing device 195 to support export of finalized content to external platforms such as email marketing services, social media scheduling tools, or text messaging services.

The display module 216 is configured to display one or more graphic user interfaces rendered by the user interface module 210. The display module 216 temporarily generates and displays various pieces of information in response to commands or operations from other modules within the application program 200. The display module 216 renders the modular editing interface presenting each content item as a discrete element, displays usage status indicators from the content usage tracking module 260, and presents search results and archived communication packages retrieved by the archive module 270. The display module 216 may provide live preview panels showing each content item in a format approximating its final appearance on the target communication channel. The displayed content in the display module 216 may be refreshed and replaced with different content upon receipt of different commands or operations.

The database engine 204 is configured to facilitate the storage, management, and retrieval of data to and from one or more storage mediums within the computing system 100. The database engine 204 may be implemented using a relational database management system, a document-oriented database, or a cloud-based storage service. The database engine 204 stores prompt templates maintained by the prompt engine 220, communication packages and associated metadata managed by the archive module 270, user account information managed by the user module 212, and usage status data maintained by the content usage tracking module 260. The database engine 204 comprises a search engine component for searching through stored data based on queries received from the archive module 270.

The computing system 100 communicates with external devices via the network 190. The network 190 may correspond to a local area network, a wide area network, the Internet, a direct peer-to-peer network, or an indirect peer-to-peer network. The network 190 may comprise copper transmission cables, optical transmission fibers, wireless transmission, routers, firewalls, switches, gateway computers, or edge servers.

The user computing device 145 comprises a computing device operated by a user such as a church staff member, volunteer, or ministry leader. The user computing device 145 accesses the application program 200 via the network 190 using a web browser or dedicated client application. The user computing device 145 may comprise a desktop computer, a laptop computer, a tablet, a smartphone, or any other computing device capable of rendering the user interface module 210 and transmitting input data to the application program 200.

The administrator computing device 185 comprises a computing device operated by an administrator responsible for managing the application program 200 and user accounts. The administrator computing device 185 accesses administrative functions of the application program 200 via the network 190. The administrator computing device 185 may be used to configure system settings, manage user roles and permissions through the user module 212, monitor system performance, and perform maintenance operations on the database engine 204.

The third-party computing device 195 comprises one or more external computing systems operated by third-party service providers. The third-party computing device 195 may include servers hosting email marketing platforms, social media scheduling tools, text messaging services, or large language model API services. The communication module 202 interfaces with the third-party computing device 195 to transmit populated prompts to large language model services and to export finalized content to external distribution platforms. Communication between the application program 200 and the third-party computing device 195 occurs via APIs provided by the respective third-party services.

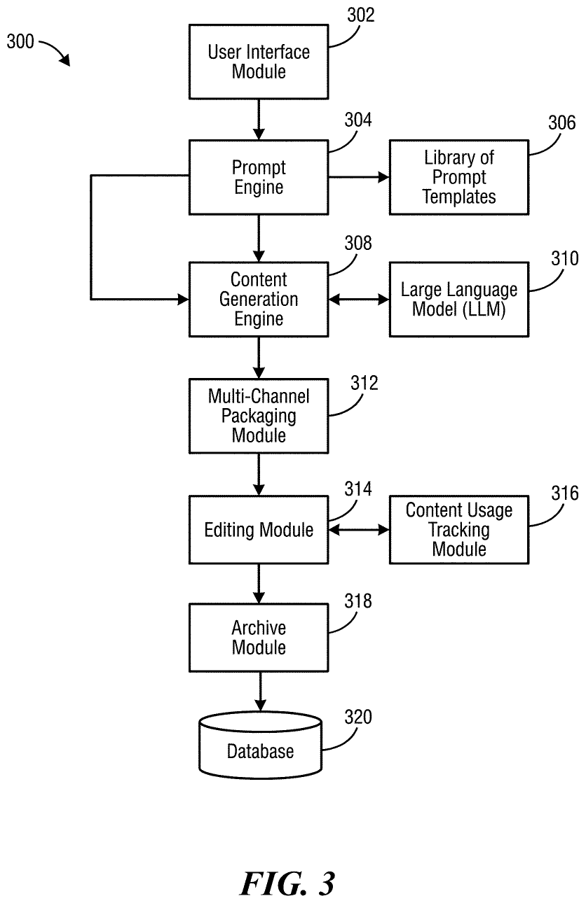

FIG. 3 illustrates a flowchart 300 of a process for generating tailored communication content for church-related events using artificial intelligence, according to some embodiments.

The flowchart 300 depicts the data flow and functional interactions between components of the system as structured input data is transformed into a stored multi-channel communication package. The process begins at the user interface module 302 and proceeds through a series of processing stages until the finalized communication package is persisted in the database 320.

The user interface module 302 provides a web-based interface through which a user enters input data describing a church event, ministry update, or campaign. The input data comprises structured fields including an event name, an event date, a target audience descriptor, a call-to-action message, and optionally a preferred tone or theme. The user interface module 302 validates the input data to ensure completeness and coherence. Upon successful validation, the user interface module 302 transmits the validated input data to the prompt engine 304 for processing. The arrow from user interface module 302 to prompt engine 304 represents this transmission of validated input data.

The prompt engine 304 receives the validated input data from the user interface module 302 and maps the data to one or more prompt templates retrieved from the library of prompt templates 306. The library of prompt templates 306 comprises a collection of pre-structured prompt templates, each designed to generate content suitable for a specific communication channel such as email, social media, SMS, or spoken announcement scripts. Each prompt template in the library of prompt templates 306 comprises a textual structure with placeholder variables corresponding to input data fields. The prompt engine 304 selects the appropriate prompt templates from the library of prompt templates 306 based on the communication channels specified by the user or defaulted by the system. The bidirectional arrow between prompt engine 304 and library of prompt templates 306 represents the retrieval of prompt templates and potential updates to the template library. The prompt engine 304 populates the placeholder variables in each selected prompt template with the corresponding values from the input data to produce complete prompts. The prompt engine 304 may also enrich the prompts with contextual information derived from a communication style profile associated with the church. Upon completing prompt population, the prompt engine 304 transmits the populated prompts to the content generation engine 308.

The content generation engine 308 receives the populated prompts from the prompt engine 304 and interfaces with the large language model (LLM) 310 to generate communication content. The large language model 310 may comprise a transformer-based neural network architecture such as OpenAI's GPT or similar models capable of generating coherent natural language text based on input prompts. The content generation engine 308 transmits each populated prompt to the large language model 310 via an application programming interface. The large language model 310 processes each prompt and generates text that fulfills the prompt instructions. The bidirectional arrow between content generation engine 308 and large language model 310 represents the transmission of prompts to the model and the receipt of generated text responses. The content generation engine 308 may transmit multiple prompts in parallel or in sequence, with each prompt corresponding to a different communication channel. The content generation engine 308 receives the generated text from the large language model 310 and passes the raw generated content to the multi-channel packaging module 312. The content generation engine 308 supports both initial generation workflows, where a full batch of prompts is processed, and selective regeneration workflows, where a single targeted prompt is processed to regenerate only one content item.

The multi-channel packaging module 312 receives raw generated content from the content generation engine 308 and formats the content into a structured communication package. The communication package comprises a plurality of content items, each formatted for a respective communication channel. The multi-channel packaging module 312 applies channel-specific formatting rules to each content item. For email content, the multi-channel packaging module 312 structures the output into a subject line and a message body with appropriate paragraph formatting. For social media content, the multi-channel packaging module 312 truncates or adjusts text to conform to character limits imposed by various platforms. For SMS content, the multi-channel packaging module 312 enforces brevity constraints and removes unsupported formatting. For spoken announcement scripts, the multi-channel packaging module 312 formats the content for verbal delivery. The multi-channel packaging module 312 tags each content item with metadata indicating the content type, the target communication channel, and the generation timestamp. The multi-channel packaging module 312 assembles the formatted content items into a unified communication package data structure and transmits the package to the editing module 314.

The editing module 314 receives the communication package from the multi-channel packaging module 312 and provides a granular interface for reviewing and modifying the AI-generated content. The editing module 314 renders each content item as a discrete, individually selectable element within the user interface. The editing module 314 displays each content item in an editable field where users can make real-time adjustments to the text. The editing module 314 tracks changes made by users and may maintain a version history for each content item. The editing module 314 facilitates selective regeneration by allowing users to request regeneration of a specific content item without affecting other items in the communication package. When a user requests selective regeneration, the editing module 314 passes the targeted request back to the content generation engine 308, which regenerates only the selected content item. The editing module 314 replaces the previous version of the content item with the newly generated content while preserving all other content items unchanged.

The editing module 314 interfaces with the content usage tracking module 316. The content usage tracking module 316 monitors and records the status of each content item within the communication package. The content usage tracking module 316 allows users to mark individual content items as used, indicating that the content has been deployed to a communication channel. When a user marks a content item as used, the content usage tracking module 316 updates metadata associated with the content item to indicate a used status. The metadata may further comprise a timestamp indicating when the content item was marked as used, a user identifier indicating which user marked the content item, and an identifier of the destination platform where the content was deployed. The bidirectional arrow between editing module 314 and content usage tracking module 316 represents the exchange of usage status information. The content usage tracking module 316 provides usage status indicators to the editing module 314 for display within the user interface, helping users avoid accidental duplication of messaging across communication cycles.

The archive module 318 receives the finalized communication package from the editing module 314 and stores the package in the database 320. The archive module 318 saves the communication package along with associated metadata including the event title, event date, ministry type, target audience, generation timestamp, author identifier, and usage status for each content item as recorded by the content usage tracking module 316. The archive module 318 may also apply tags or labels specified by the user to facilitate organization and retrieval.

The database 320 comprises a persistent storage system for storing communication packages and associated metadata. The database 320 may be implemented using a relational database management system, a document-oriented database, or a cloud-based storage service. The database 320 stores all generated communication packages in a searchable format. The archive module 318 interfaces with the database 320 to perform storage, retrieval, and search operations. Users may retrieve previously stored communication packages from the database 320 via the archive module 318 based on filter criteria such as keyword, event date, event title, ministry type, audience type, or communication channel. Retrieved communication packages may be loaded into the editing module 314 for review or cloned for adaptation to new events.

The flowchart 300 represents a complete processing cycle from user input to persistent storage. The sequential arrangement of modules reflects the primary data flow, while the bidirectional connections to the library of prompt templates 306, the large language model 310, and the content usage tracking module 316 represent supporting interactions that enhance the content generation and management process.

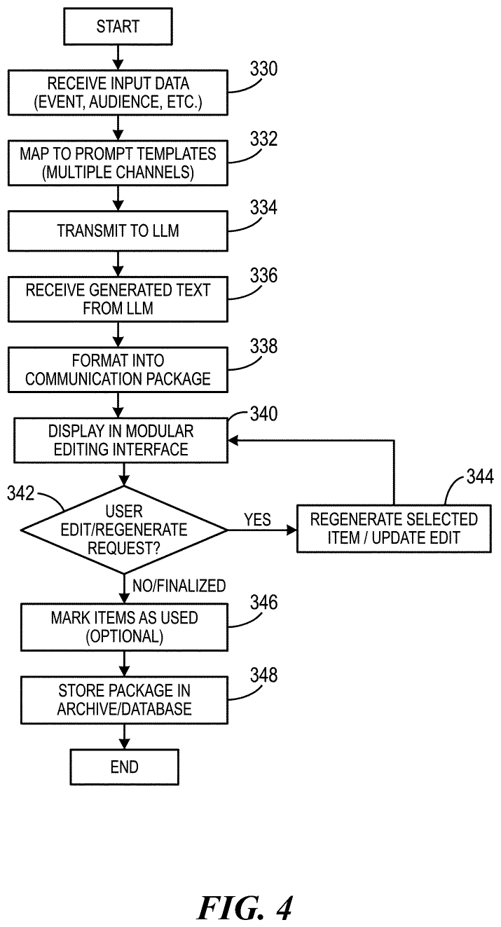

FIG. 4 illustrates a flowchart of a method for generating tailored communication content for church-related events using artificial intelligence, according to some embodiments.

The method begins at the START block and proceeds through a series of steps that transform user input into a stored multi-channel communication package. The method includes a decision point that enables iterative refinement of generated content through selective regeneration.

At step 330, the system receives input data comprising event information and audience details. A user accesses a web-based user interface and enters structured input data describing a church event, ministry update, or campaign. The input data may comprise an event name, an event date, a target audience descriptor, a call-to-action message, a ministry type, and a preferred tone or theme. The user interface validates the input data to ensure completeness and coherence before proceeding to the next step.

At step 332, the system maps the received input data to prompt templates corresponding to multiple communication channels. A prompt engine retrieves one or more pre-structured prompt templates from a library of prompt templates. Each prompt template is designed to generate content suitable for a specific communication channel such as email, social media, SMS, or spoken announcement scripts. The prompt engine selects the appropriate templates based on the communication channels specified by the user or defaulted by the system. The prompt engine populates placeholder variables within each selected template with corresponding values from the input data to produce complete prompts ready for submission to a large language model.

At step 334, the system transmits the populated prompts to a large language model (LLM). A content generation engine interfaces with the large language model via an application programming interface. The content generation engine may transmit multiple prompts in parallel or in sequence, with each prompt corresponding to a different communication channel. The large language model may comprise a transformer-based neural network architecture capable of generating coherent natural language text based on input prompts.

At step 336, the system receives generated text from the large language model. The large language model processes each transmitted prompt and returns generated text as a response. The content generation engine receives the generated text for each communication channel and passes the raw generated content to downstream processing.

At step 338, the system formats the generated text into a communication package. A multi-channel packaging module receives the raw generated content and applies channel-specific formatting rules to produce a structured communication package. The communication package comprises a plurality of content items, each formatted for a respective communication channel. For email content, the module structures the output into a subject line and message body. For social media content, the module adjusts text to conform to character limits. For SMS content, the module enforces brevity constraints. For spoken announcement scripts, the module formats content for verbal delivery. The module tags each content item with metadata indicating content type, target channel, and generation timestamp.

At step 340, the system displays the communication package in a modular editing interface. An editing module renders each content item as a discrete, individually selectable element within the user interface. Each content item appears in an editable field where users can review the generated content and make real-time adjustments to the text.

At decision step 342, the system determines whether a user has requested an edit or regeneration of a content item. The user may review the displayed content items and decide whether to accept the generated content as finalized or to request modifications. If the user selects a specific content item for regeneration or makes an edit, the method proceeds to step 344. If the user indicates that the content is finalized or does not request any edits or regeneration, the method proceeds to step 346.

At step 344, the system regenerates the selected item or updates the edit. When a user requests selective regeneration of a specific content item, the editing module passes a targeted request to the content generation engine. The content generation engine transmits a focused prompt to the large language model to regenerate only the selected content item. The large language model processes the targeted prompt and returns newly generated text. The editing module replaces the previous version of the content item with the newly generated content while preserving all other content items in the communication package unchanged. If the user manually edits a content item rather than requesting regeneration, the editing module updates the content item with the user's modifications. After completing the regeneration or edit update at step 344, the method returns to step 340 to display the updated communication package in the modular editing interface. This loop allows iterative refinement of individual content items until the user is satisfied with the entire communication package.

At step 346, the system optionally marks items as used. A content usage tracking module allows users to mark individual content items as used, indicating that the content has been or will be deployed to a communication channel. When a user marks a content item as used, the content usage tracking module updates metadata associated with the content item to indicate a used status. The metadata may further comprise a timestamp indicating when the item was marked as used and a user identifier indicating which user marked the item. This step is optional, as indicated in the figure, and users may proceed to storage without marking items as used.

At step 348, the system stores the communication package in an archive database. An archive module saves the finalized communication package to a database along with associated metadata. The metadata may include the event title, event date, ministry type, target audience, generation timestamp, author identifier, and usage status for each content item. The database stores the communication package in a searchable format that supports retrieval based on filter criteria such as keyword, event date, event title, ministry type, audience type, or communication channel. Users may later retrieve stored packages for reference or clone packages for adaptation to future events.

The method concludes at the END block after the communication package has been stored in the archive database.

The flowchart illustrates a complete content generation cycle with support for iterative refinement through the decision loop at steps 340, 342, and 344. This iterative capability enables users to selectively regenerate individual content items without regenerating the entire communication package, thereby preserving satisfactory content while refining only the elements that require adjustment.

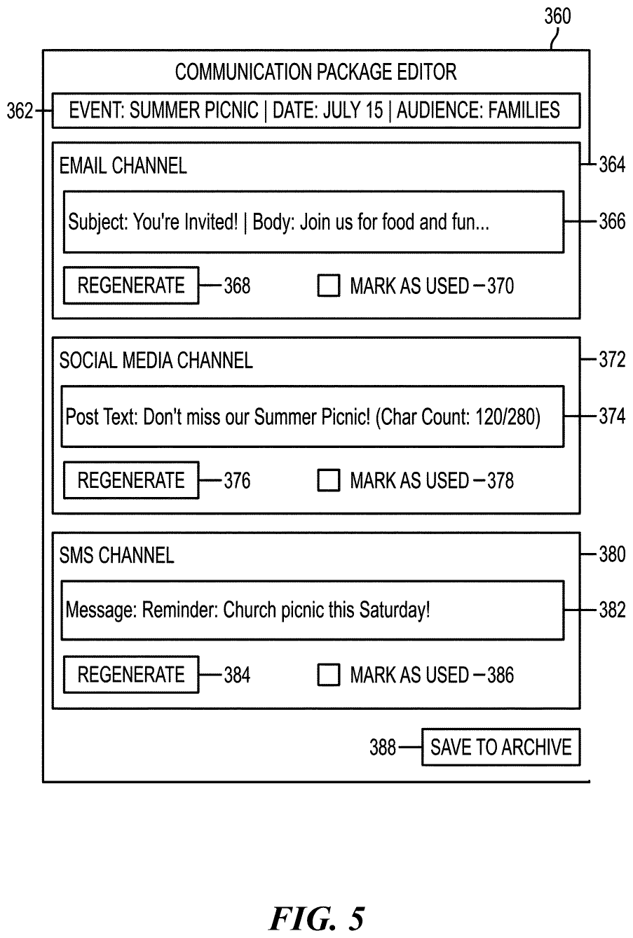

FIG. 5 illustrates an exemplary user interface screen 360 of a communication package editor displaying a modular editing interface for reviewing and managing AI-generated multi-channel communication content, according to some embodiments.

The communication package editor 360 presents a communication package comprising a plurality of content items, each formatted for a respective communication channel. The communication package editor 360 renders each content item as a discrete, individually selectable element, enabling users to review, edit, regenerate, and mark content items independently without affecting other items in the package.

The event information header 362 displays metadata associated with the communication package. In the illustrated embodiment, the event information header 362 displays “EVENT: SUMMER PICNIC|DATE: JULY 15|AUDIENCE: FAMILIES” indicating the event name, event date, and target audience that were provided as input data during the content generation process. The event information header 362 provides context for the user reviewing the generated content and confirms the input parameters used to generate the communication package.

The email channel section 364 presents content generated for the email communication channel. The email channel section 364 comprises an email content field 366 displaying the generated email content. In the illustrated embodiment, the email content field 366 displays “Subject: You're Invited!|Body: Join us for food and fun . . . ” indicating a subject line and a portion of the message body generated by the content generation engine for email distribution. The email content field 366 may be an editable field that allows users to make real-time adjustments to the displayed text.

The email channel section 364 comprises a regenerate button 368. The regenerate button 368 provides a user-selectable control that, when activated, initiates selective regeneration of only the email content item. Upon activation of the regenerate button 368, the editing module passes a targeted regeneration request to the content generation engine. The content generation engine transmits a focused prompt to the large language model to regenerate the email content. The large language model processes the prompt and returns newly generated email text. The editing module replaces the content displayed in the email content field 366 with the newly generated email content while preserving all other content items in the communication package unchanged.

The email channel section 364 comprises a mark as used checkbox 370. The mark as used checkbox 370 provides a user-selectable control that, when activated, marks the email content item as used. Upon activation of the mark as used checkbox 370, the content usage tracking module updates metadata associated with the email content item to indicate a used status. The metadata may further comprise a timestamp indicating when the item was marked as used and a user identifier indicating which user marked the item. The mark as used checkbox 370 provides visual feedback indicating whether the email content has been deployed, helping users avoid accidental duplication of the email content across communication cycles.

The social media channel section 372 presents content generated for the social media communication channel. The social media channel section 372 comprises a social media content field 374 displaying the generated social media post. In the illustrated embodiment, the social media content field 374 displays “Post Text: Don't miss our Summer Picnic! (Char Count: 120/280)” indicating the post text generated by the content generation engine along with a character count indicator. The character count indicator shows that the generated post contains 120 characters out of a maximum of 280 characters, reflecting channel-specific formatting constraints applied by the multi-channel packaging module for social media platforms with character limits. The social media content field 374 may be an editable field that allows users to modify the displayed text.

The social media channel section 372 comprises a regenerate button 376. The regenerate button 376 provides a user-selectable control that, when activated, initiates selective regeneration of only the social media content item. The regeneration process for the social media content operates in the same manner as described for the regenerate button 368, with the content generation engine regenerating only the social media post while preserving all other content items unchanged.

The social media channel section 372 comprises a mark as used checkbox 378. The mark as used checkbox 378 provides a user-selectable control that, when activated, marks the social media content item as used. The mark as used checkbox 378 operates in the same manner as described for the mark as used checkbox 370, updating metadata to indicate that the social media post has been deployed.

The SMS channel section 380 presents content generated for the SMS communication channel. The SMS channel section 380 comprises an SMS content field 382 displaying the generated text message. In the illustrated embodiment, the SMS content field 382 displays “Message: Reminder: Church picnic this Saturday!” indicating a brief text message generated by the content generation engine. The SMS content reflects brevity constraints applied by the multi-channel packaging module for text message communications. The SMS content field 382 may be an editable field that allows users to modify the displayed text.

The SMS channel section 380 comprises a regenerate button 384. The regenerate button 384 provides a user-selectable control that, when activated, initiates selective regeneration of only the SMS content item. The regeneration process for the SMS content operates in the same manner as described for the regenerate button 368, with the content generation engine regenerating only the text message while preserving all other content items unchanged.

The SMS channel section 380 comprises a mark as used checkbox 386. The mark as used checkbox 386 provides a user-selectable control that, when activated, marks the SMS content item as used. The mark as used checkbox 386 operates in the same manner as described for the mark as used checkbox 370, updating metadata to indicate that the text message has been deployed.

The save to archive button 388 provides a user-selectable control that, when activated, stores the finalized communication package in the archive database. Upon activation of the save to archive button 388, the archive module saves the communication package along with associated metadata to the database. The metadata may include the event title, event date, target audience, generation timestamp, author identifier, and usage status for each content item as indicated by the mark as used checkboxes 370, 378, and 386. The saved communication package may be retrieved later via the archive module based on filter criteria such as keyword, event date, event title, ministry type, audience type, or communication channel. Users may clone retrieved packages for adaptation to future events.

The communication package editor 360 illustrates the modular structure of the editing interface that enables users to interact with each content item independently. Each channel section presents a discrete content item with dedicated controls for selective regeneration and usage tracking. This modular design allows users to refine individual content items without regenerating the entire communication package, preserving satisfactory content while adjusting only the elements that require modification.

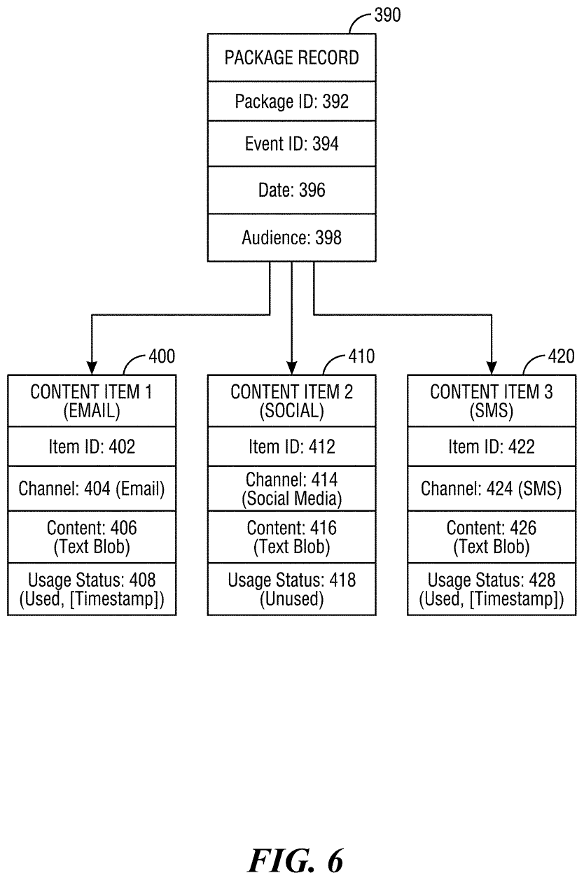

FIG. 6 illustrates an exemplary data structure diagram depicting the organization of a communication package record 390 and associated content items as stored in the archive database, according to some embodiments.

The package record 390 represents a data object stored by the archive module in the database. The package record 390 comprises metadata fields that identify and describe the communication package as a whole. The package record 390 is associated with a plurality of content item records, each representing a discrete content item formatted for a respective communication channel.

The package record 390 comprises a package ID field 392. The package ID field 392 stores a unique identifier assigned to the communication package. The package ID field 392 may comprise a numeric identifier, an alphanumeric string, a universally unique identifier (UUID), or other identifier format suitable for uniquely distinguishing the package record 390 from other package records stored in the database. The archive module uses the package ID field 392 to reference, retrieve, and manage the package record 390.

The package record 390 comprises an event ID field 394. The event ID field 394 stores an identifier associated with the church event, ministry update, or campaign for which the communication package was generated. The event ID field 394 may reference a separate event record in the database or may store an event name or title directly. The event ID field 394 enables users to search for and retrieve communication packages based on event identification criteria.

The package record 390 comprises a date field 396. The date field 396 stores the event date associated with the communication package. The date field 396 may store the date in a standardized format such as ISO 8601 or another date format supported by the database. The date field 396 enables users to search for and retrieve communication packages based on date range criteria and supports chronological sorting of archived packages.

The package record 390 comprises an audience field 398. The audience field 398 stores the target audience descriptor associated with the communication package. The audience field 398 may store a predefined audience category such as “Families,” “Youth,” “Seniors,” or “General Congregation,” or may store a custom audience descriptor provided by the user during input. The audience field 398 enables users to search for and filter communication packages based on audience type.

The package record 390 is associated with content item 1 (email) 400, content item 2 (social) 410, and content item 3 (SMS) 420. Each content item record represents a discrete content item within the communication package, formatted for a respective communication channel. The association between the package record 390 and the content item records may be implemented using foreign key relationships in a relational database, embedded documents in a document-oriented database, or other data association mechanisms supported by the database implementation.

Content item 1 (email) 400 represents the content item generated for the email communication channel. Content item 1 (email) 400 comprises an item ID field 402 that stores a unique identifier assigned to the email content item. The item ID field 402 enables the system to reference and manage the email content item independently from other content items in the package.

Content item 1 (email) 400 comprises a channel field 404 that stores an indicator identifying the communication channel for which the content item was formatted. In the illustrated embodiment, the channel field 404 stores “Email” indicating that the content item is formatted for email distribution. The channel field 404 enables users to filter and retrieve content items based on communication channel.

Content item 1 (email) 400 comprises a content field 406 that stores the generated text content as a text blob. The content field 406 may store the complete email content including subject line and message body. The content field 406 preserves the generated and potentially user-edited text for future retrieval, reference, and cloning.

Content item 1 (email) 400 comprises a usage status field 408 that stores the usage status of the content item as recorded by the content usage tracking module. In the illustrated embodiment, the usage status field 408 displays “(Used, [Timestamp])” indicating that the email content item has been marked as used and includes a timestamp recording when the item was marked. The usage status field 408 may store a Boolean indicator of used status, a timestamp, a user identifier indicating which user marked the item, and an identifier of the destination platform where the content was deployed. The usage status field 408 enables the system to display usage indicators in the user interface and helps users avoid accidental duplication of content.

Content item 2 (social) 410 represents the content item generated for the social media communication channel. Content item 2 (social) 410 comprises an item ID field 412 that stores a unique identifier assigned to the social media content item.

Content item 2 (social) 410 comprises a channel field 414 that stores “Social Media” indicating that the content item is formatted for social media distribution.

Content item 2 (social) 410 comprises a content field 416 that stores the generated social media post text as a text blob. The content field 416 preserves the generated post content for future retrieval and cloning.

Content item 2 (social) 410 comprises a usage status field 418 that stores the usage status of the social media content item. In the illustrated embodiment, the usage status field 418 displays “(Unused)” indicating that the social media content item has not been marked as used. The usage status field 418 enables the system to distinguish between deployed and undeployed content items when displaying archived packages.

Content item 3 (SMS) 420 represents the content item generated for the SMS communication channel. Content item 3 (SMS) 420 comprises an item ID field 422 that stores a unique identifier assigned to the SMS content item.

Content item 3 (SMS) 420 comprises a channel field 424 that stores “SMS” indicating that the content item is formatted for text message distribution.

Content item 3 (SMS) 420 comprises a content field 426 that stores the generated text message content as a text blob. The content field 426 preserves the brief message content formatted for SMS delivery.

Content item 3 (SMS) 420 comprises a usage status field 428 that stores the usage status of the SMS content item. In the illustrated embodiment, the usage status field 428 displays “(Used, [Timestamp])” indicating that the SMS content item has been marked as used and includes a timestamp recording when the item was marked.

The data structure illustrated in FIG. 6 enables the archive module to store, retrieve, and manage communication packages and their associated content items. The hierarchical relationship between the package record 390 and the content item records 400, 410, and 420 allows the system to maintain package-level metadata while preserving granular content and usage status information for each individual content item. This structure supports the searchable archive functionality, enabling users to retrieve packages based on filter criteria stored in the package record 390 and to view usage status information stored in each content item record. The structure also supports cloning functionality by preserving all package and content item data in a format that can be duplicated and modified for adaptation to new events.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented system for generating communication content for faith-based organizations, the system comprising:
one or more processors; and
one or more non-transitory computer-readable storage media storing instructions that, when executed by the one or more processors, cause the system to:
receive, via a user interface, input data comprising event information including at least an event name, a date, a target audience, and a call-to-action message;
select, from a library of pre-structured prompt templates designed for faith-based organization communications, one or more prompt templates corresponding to a plurality of communication channels;
generate, using a large language model and the selected one or more prompt templates populated with the input data, a communication package comprising a plurality of content items, wherein each content item of the plurality of content items is formatted for a respective communication channel of the plurality of communication channels;
display the communication package in a modular editing interface, wherein each content item of the plurality of content items is presented as a discrete, individually selectable element;
receive a user selection of a single content item from the plurality of content items for regeneration;
regenerate, using the large language model, only the selected single content item while preserving all other content items of the plurality of content items unchanged; and
store the communication package in a searchable database with associated metadata.

2. The system of claim 1, wherein the plurality of communication channels comprises two or more of: email, social media, short message service (SMS), and spoken announcement script.

3. The system of claim 1, wherein the instructions further cause the system to:
receive a user input marking a content item as used; and
update metadata associated with the content item to indicate a used status, thereby preventing accidental duplication of the content item across communication cycles.

4. The system of claim 3, wherein the metadata further comprises a timestamp indicating when the content item was marked as used and a user identifier indicating which user marked the content item as used.

5. The system of claim 1, wherein the searchable database supports retrieval of previously stored communication packages based on one or more filter criteria selected from:
keyword, event date, event title, ministry type, audience type, and communication channel.

6. The system of claim 5, wherein the instructions further cause the system to:
retrieve a previously stored communication package from the searchable database; and
clone the retrieved communication package to create a new communication package for editing and adaptation.

7. The system of claim 1, wherein the pre-structured prompt templates comprise embedded linguistic structures and terminology conventions configured to generate content aligned with communication standards of faith-based organizations.

8. The system of claim 1, wherein the instructions further cause the system to:
authenticate a user via a user authentication module; and
assign to the user a role selected from a plurality of roles comprising content creator, editor, and approver, wherein each role is associated with different access permissions within the system.

9. A computer-implemented method for generating multi-channel communication content for church-related events, the method comprising:
receiving, by one or more processors via a web-based user interface, structured input data describing a church event, the structured input data comprising an event name, an event date, a target audience descriptor, and a call-to-action;
mapping, by the one or more processors, the structured input data to a plurality of prompt templates, wherein each prompt template of the plurality of prompt templates is configured to generate content for a different communication channel;
transmitting, by the one or more processors, the plurality of prompt templates populated with the structured input data to a large language model;
receiving, by the one or more processors from the large language model, generated text for each of the plurality of prompt templates;
assembling, by the one or more processors, the generated text into a communication package comprising a plurality of discrete content items including at least an email message, a social media post, and a text message;
presenting, by the one or more processors via the web-based user interface, the communication package in an editing interface wherein each discrete content item is independently selectable;
receiving, by the one or more processors, a regeneration request specifying a particular content item of the plurality of discrete content items;
regenerating, by the one or more processors using the large language model, the particular content item without regenerating remaining content items of the plurality of discrete content items; and
storing, by the one or more processors, the communication package and associated metadata in a cloud-based database.

10. The method of claim 9, further comprising:
receiving a user input indicating that a content item has been used; and
recording, in the associated metadata, a usage status for the content item, wherein the usage status is visible in a dashboard view to prevent duplicate use of the content item.

11. The method of claim 9, further comprising:
receiving a search query specifying one or more search parameters;
querying the cloud-based database based on the one or more search parameters; and
returning one or more previously stored communication packages matching the one or more search parameters.

12. The method of claim 11, further comprising:
receiving a selection of a previously stored communication package; and
generating an editable copy of the selected previously stored communication package for adaptation to a new event.

13. The method of claim 9, wherein the plurality of prompt templates further comprise channel-specific formatting constraints including character length limits for social media posts and brevity requirements for text messages.

14. The method of claim 9, further comprising:
prior to the receiving step, performing a website scan of an existing website associated with a church, wherein the website scan extracts tone markers, personality indicators, and communication style characteristics from content of the existing website;
generating a communication style profile based on the extracted tone markers, personality indicators, and communication style characteristics; and
incorporating the communication style profile into the plurality of prompt templates such that the generated text reflects a consistent voice matching the existing website.

15. The method of claim 9, further comprising:
applying a member journey map framework to the structured input data, wherein the member journey map framework structures communications around stages of a church member experience;
generating, based on the member journey map framework, a coordinated sequence of messages comprising at least a pre-event announcement, an event reminder, and a post-event follow-up message; and
associating each message in the coordinated sequence with a designated timing parameter relative to the event date.

16. A computer program product for generating faith-based organization communications, the computer program product comprising:
one or more non-transitory computer-readable storage media having program instructions embodied therewith, the program instructions executable by one or more processors to cause the one or more processors to perform operations comprising:
displaying a user interface configured to receive input describing a promotional event for a faith-based organization, the input comprising at least an event identifier, a date, an audience type, and a desired action;
processing the input through a prompt engine comprising a library of pre-configured prompt templates, wherein each pre-configured prompt template is structured to generate content suitable for a respective communication channel;
invoking a large language model to generate, based on the processed input, a set of content outputs comprising content for at least three different communication channels;
formatting each content output according to conventions of the respective communication channel to produce a multi-channel communication package;
rendering the multi-channel communication package in a modular display, wherein each content output is displayed as a separately editable and separately regenerable component;
responsive to receiving a regeneration command directed to a specific component, invoking the large language model to regenerate only the specific component while maintaining all other components of the multi-channel communication package; and
persisting the multi-channel communication package to a storage system configured to support keyword-based and filter-based retrieval of stored communication packages.

17. The computer program product of claim 16, wherein the operations further comprise:
receiving a marking input designating a component as having been deployed; and
associating a usage indicator with the component in the storage system, wherein the usage indicator is displayed in the modular display to indicate prior deployment of the component.

18. The computer program product of claim 16, wherein the at least three different communication channels comprise email, social media, and short message service (SMS).

19. The computer program product of claim 16, wherein the operations further comprise:
authenticating a user;
determining a permission level associated with the user; and
restricting access to one or more operations based on the determined permission level.

20. The computer program product of claim 16, wherein the library of pre-configured prompt templates comprises templates incorporating terminology and structural conventions specific to communications of faith-based organizations.
